(19) United States
(12) Patent Application Publication
(10) Pub. No.: US 2010/0192674 A1
(43) Pub. Date: Aug. 5, 2010

(54) Method for directly injecting a liquid sample into a capillary chromatography column and apparatus for implementing the method

(75) Inventors: Mario Galli, Legnano (IT); Stefano Galli, Legnano (IT); Albino Sironi, Pozzo d'Adda (IT)

Correspondence Address: Themis Law, 7660 Fay Ave Ste H-535, La Jolla, CA, 92037, US

(73) Assignee: DANI INSTRUMENTS S.P.A., Cologno Monzese (MI) (IT)

(21) Appl. No.: 12/679,370

(22) PCT Filed: Sep. 3, 2008
(86) PCT No.: PCT/EP08/61609

§ 371 Date: Mar. 22, 2010

(30) Foreign Application Priority Data
Sep. 27, 2007 (IT) VE2007A000065

(51) Int. Cl. G01N 30/24

(52) U.S. Cl. 73/23.41

(57) ABSTRACT

A method for directly injecting a liquid sample into a capillary chromatography column, by which a liquid sample that includes the substance to be analyzed and the relative solvent is withdrawn from a vial with an automatic sampler having a syringe with a needle, and is then introduced into an insert, with which the injector of the chromatograph is provided, such that the terminal portion of the chromatography column is coaxially inserted into the needle to cause migration by capillarity of a part of the sample from the needle to the column. Excess sample overflowing from the needle at the moment in which the end of said column is inserted thereinto is received in a cavity, and the residence time of the end of the column within the needle is controlled.

### FIELD OF THE INVENTION

The present invention relates to a method for directly injecting a liquid sample into a capillary chromatography column and an apparatus for implementing the method.

### BACKGROUND OF THE INVENTION

Chromatographs and in particular gas chromatographs are widely used for analysis in many sectors, such as the petrochemical, environmental, pharmaceutical, perfume and fragrance sectors.

A gas chromatography system is traditionally composed of a gas chromatograph, consisting of an instrument composed of three basic parts: an injector, a heating chamber (oven) and a detector system.

The heating chamber contains internally a gas chromatography column, forming the core of the system and within which the analyte substances of interest are separated.

Different types of injectors exist by which the different types of sample introduction are achieved. In a particular type of injector, known as “on-column”, the sample to be analyzed is transferred directly into the column without passing through the vapour phase. This injection method presents many advantages compared with other transfer methods, and in particular avoids the so-called discrimination effect of the syringe needle and the decomposition or alteration of the nature of thermolabile components, and moreover enables absolute injection repeatability to be achieved.

WO2004/077046 describes a particular type of on-column injector which enables the sample for analysis to be injected, in volumes variable from nano-volumes to large volumes by applying the “large volume” technique, into capillary columns with an inner diameter less than 250 micron. This comprises in practice a liquid phase split, which for introducing the sample uses the capillarity of the column tube.

In this known technique, the terminal of the capillary chromatography column enters the syringe needle, left filled with liquid, and by capillarity causes to migrate into the column a quantity of sample of the order of nano-litres, which then under the action of the carrier gas is made to advance along the column to achieve separation.

This known technique, which is carried out manually, cannot be considered satisfactory, as the manual aspect of the insertion operations is difficult to reconcile with the need for reproducibility required by the constancy of the sample quantity withdrawn by the column due to the capillary effect.

In this respect, as the capillary column in the syringe needle can vary from a few seconds to some hundredths of a second, it is evidently virtually impossible to carry out these insertions manually. Moreover, given the need to also carry out other operations manually, this known technique is evidently not applicable in the laboratory, in which a series of controls have to be undertaken automatically in continuation.

A further problem presented by the known manual technique of inserting a capillary column into the syringe needle is linked to the minimal differences, virtually of a few tenths of a micron, between the syringe inner diameter and the outer diameter of the gas chromatography column.

This implies that unavoidable capillary phenomena existing between the internal wall of the insert and the external wall of the needle cause the extraction of an uncontrolled part of the sample from the column, when the needle is withdrawn, and this modifies the quantity of sample that has already entered the column and has to be measured, and in some cases can also cause the breaking of the meniscus of the sample within the column, thus invalidating even more the precision of the definition and, in any case, rendering it not repeatable.

### SUMMARY OF THE INVENTION

An object of the invention is to eliminate these drawbacks by proposing a method and apparatus which enable the on-column injection described in the aforesaid WO2004/077046 to be effected automatically with a high guarantee of precision and repeatability.

This and other objects which will be apparent from the ensuing description are attained according to the invention by a method for directly injecting a liquid sample into a capillary chromatography column, by which the substance to be analyzed and the relative solvent are withdrawn from a vial with an automatic sampler having a syringe with a needle, and is then introduced into an insert provided in the injector of the chromatograph is provided, such that the terminal portion of the chromatographic column and of the needle are kept in coaxial position with the terminal portion of the column inserted into the terminal portion of the needle, such to cause migration by capillarity of a part of the sample from the needle to the column, and to cause excess sample to overflow from the needle, when the end of the column is inserted into a cavity in the portion of insert surrounding the terminal portion of said needle. The residence time of the terminal portion of the column within the needle is controlled.

An apparatus is also disclosed, which is configured to perform the above described method.

### BRIEF DESCRIPTION OF THE DRAWINGS

A preferred embodiment of the present invention is further clarified hereinafter with reference to the accompanying drawings, in which:

FIG. 1 shows schematically an automatic sampler used in the apparatus of the invention,

FIG. 2 is an enlarged detailed view of the part lying within the circle of FIG. 1,

FIG. 3 is an enlarged detailed view of the injector,

FIG. 4 shows schematically the insert with which the injector of the gas chromatograph is provided, and

FIGS. 5A-5D show schematically four successive operative steps in the process of transferring the liquid sample from the syringe needle to the column.

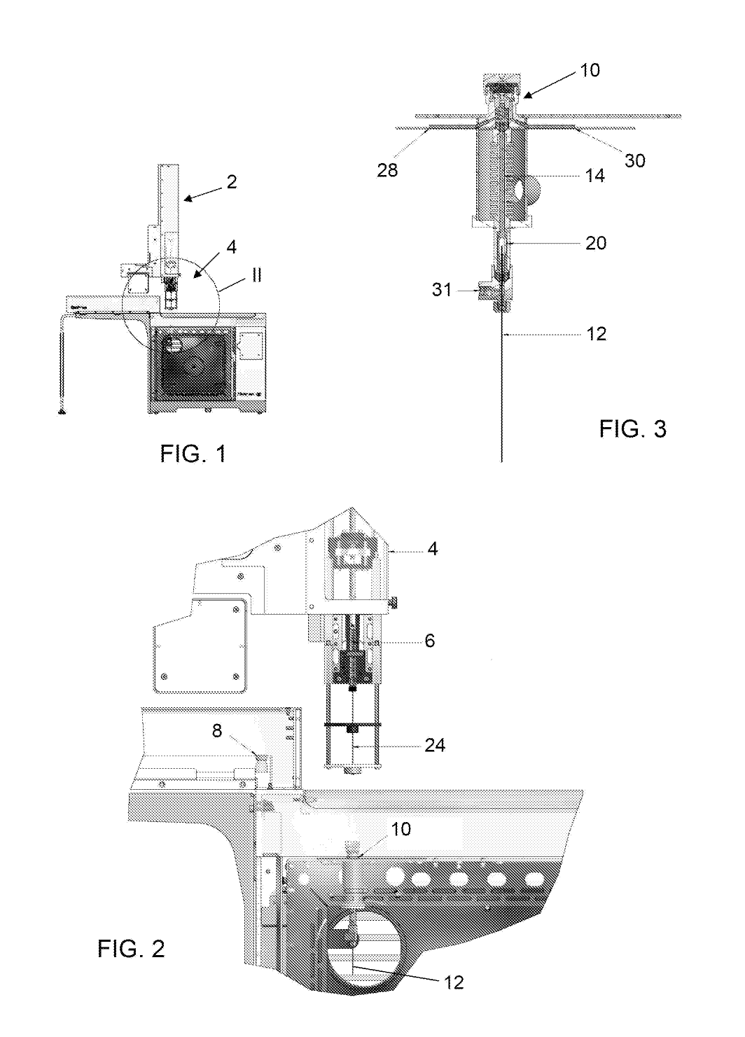

### DETAILED DESCRIPTION OF THE INVENTION

As it can be seen from the figures, the apparatus of the invention comprises an automatic sampler, indicated overall by 2 and provided with a mechanized support 4 for a syringe 6, which can be moved between a position in which it withdraws the sample to be analyzed from a container or vial and a position in which it inserts the withdrawn sample into the injector 10 of a capillary chromatography column 12, the term “chromatography column” 12 meaning a capillary tube of any material, suitably treated for carrying out analyses, i.e. either a capillary tube filled with stationary phase, or a capillary tube not filled with stationary phase (precolumn).

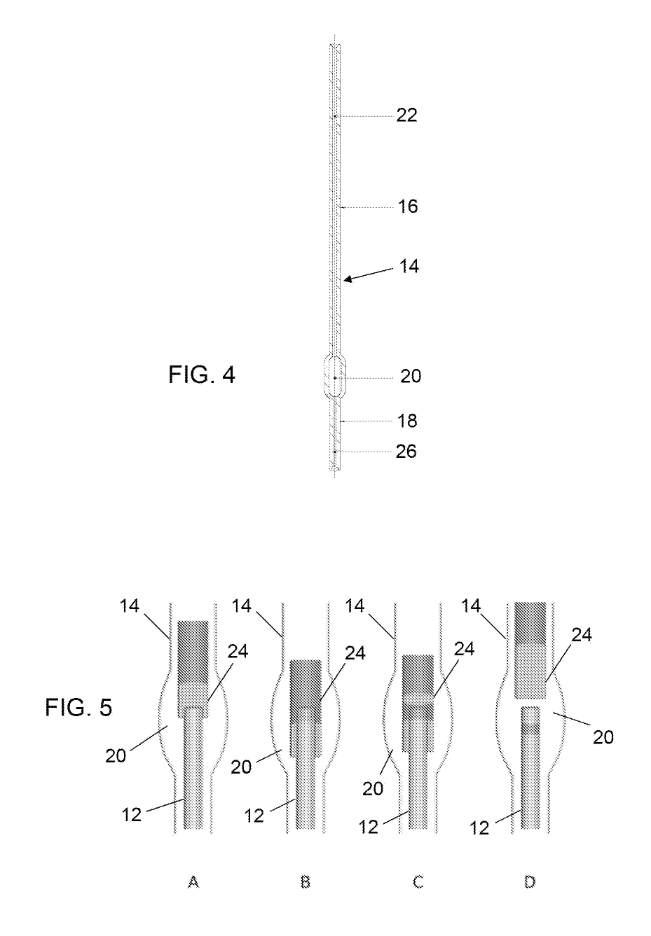

The injector 10 is provided with an insert 14 (liner) shown in FIG. 4 and consisting of a borosilicate glass tube presenting two straight portions 16 and 18, separated by a widened portion 20.

The upper straight portion 16 presents a greater-diameter axial cavity 22 for guiding the needle 24 of the syringe 6, while the lower straight portion 18 presents a lesser-diameter axial cavity 26, for guiding the terminal portion of the chromatography column 12.

While the terminal portion of the chromatography column 12 is axially fixed relative to the liner 14 and has its end opening into the widened portion 20, the needle 24 is axially movable relative to the liner 14 in order to be able to be brought into the injection position, in which the terminal portion of the column 12 is inserted into said needle 24.

A carrier gas inlet 28 and two outlets 30 and 31 are connected to the injector 10 in traditional manner, so that the carrier gas flow opens into the axial cavity 22 of the liner 14 and feeds the chromatography column, two purge streams thereof ensuring that the injector is clean.

The apparatus of the invention also comprises a control unit for controlling the programmed sequence of the various operative steps, as described below.

Initially the sampler 2 causes the needle 24 of the syringe 6 to descend onto the preselected vial 8 to withdraw the predetermined sample quantity.

Having withdrawn the sample, the sampler 2 automatically adjusts the level of its meniscus within the needle 24 to a predetermined height, then inserts the needle 24 into the axial cavity 22 of the upper portion 16 of the liner 14, until its tip is positioned within the widening 20.

Within this widening 20, in which the terminal portion of the column 12 is already housed because of the centered positioned of the two parts, ensured by the coaxiality of their guide cavities 22 and 26, said terminal portion enters the interior of the needle 24 (FIG. 5A) until the end of that portion reaches the liquid present in the needle (FIG. 5B). The operative conditions are evidently determined such as to enable this operation and more particularly the height of the meniscus to be regulated on the basis of the length of the terminal portion which enters the needle, in order to ensure that the end of said terminal portion is immersed in the liquid contained in the needle. As the entry of the column terminal portion into the needle could cause sample to escape therefrom, the purpose of the widening 20 is to receive this excess sample quantity, to prevent discrimination effects on the sample and injector contamination, with consequent memory effect.

For the entire time in which the end of the column 12 is immersed in the liquid present in the needle, the liquid migrates into the column by capillarity, in a quantity linked to the residence time of the end of the chromatography column within the liquid sample contained in the syringe needle.

As this residence time, generally of the order of fractions of a second, can be regulated with high precision, the liquid quantity to be transferred into the column can be determined with like precision, this ensuring high measurement reproducibility, not achievable manually.

After the determined time, the sampler 2 automatically raises the syringe 6, to raise the needle 24 by the amount necessary to detach the sample meniscus from the end of the column 12 (FIG. 5C) and prevent sample migration thereinto, or to completely separate the needle 24 from the column 12 (FIG. 5D).

The sample migration from the needle to the column causes the meniscus height to rise, which, especially if large volumes of sample to be analyzed are injected, could cause early detachment of the column end from the sample contained in the needle 24, hence the relative meniscus height could be varied during the column residence in the needle, such as to ensure that the column end is always immersed in the sample contained in the needle. This variation can be achieved either by raising the column or by lowering the needle or by simultaneously raising the column and lowering the needle, or by operating the syringe plunger.

What is claimed is:

1. A method of directly injecting a liquid sample into a capillary chromatography column of a chromatograph, the method comprising:
providing a liquid sample in a vial, the sample comprising a substance to be analyzed and the relative solvent;
withdrawing the substance with an automatic sampler provided with a syringe having needle; and
introducing the substance into an insert coupled to an injector of the chromatograph,
wherein terminal portions of the chromatography column and of the needle are kept in coaxial position after insertion of the terminal portion of the chromatography column into the terminal portion of the needle, such to cause migration by capillarity of a part of the sample from the needle to the column,
wherein an overflow of excess sample material from the needle, when an end of the column is inserted into the needle, is received in a cavity in a portion of the insert surrounding the terminal portion of said needle, and
wherein residence time of the terminal portion of the column within the needle is controlled.

2. The method as claimed in claim 1, further comprising the steps of:
after filling the needle of the syringe with the sample to be analyzed, applying a light suction to the syringe to withdraw a sample meniscus from the needle tip to a predetermined extent; and
thereafter, introducing the needle into the insert of said injector until the end of said column penetrates for a predetermined depth into the sample contained in the needle.

3. The method as claimed in claim 2, wherein, while the sample to be analyzed is migrating from the needle to the chromatography column, the sample meniscus is caused to move toward the needle tip to such an extent as to compensate the withdrawal of said meniscus from said tip by effect of migration.

4. The method as claimed in claim 3, wherein the meniscus is caused to move by axially moving the needle relative to the end of the column.

5. The method as claimed in claim 3, wherein the meniscus is caused to move by operating a plunger of said syringe.

6. An apparatus for implementing the method in accordance with claim 1, comprising:
an automatic sampler provided with a syringe, which has a needle for withdrawing from a vial a sample to be subjected to chromatographic analysis;
an injector associated with a capillary chromatography column, into which said sample is to be introduced;
an insert coupled to said injector and provided with a first cylindrical cavity for guiding said needle, and a second cylindrical cavity aligned with the first cylindrical cavity for guiding a terminal portion of said column; and
means for positioning the terminal portion of said column coaxially within said needle (24),
wherein at a portion in which an end of said column penetrates into said needle, the insert includes a cavity surrounding a terminal portion of said needle and having sufficient dimensions to receive excess sample material overflowing from said needle when the end of said column is inserted into the terminal portion of said needle, p1 wherein the injector presents at least one outlet for a fixed or adjustable gas stream to clean the injector, and
wherein the sampler comprises means for controlling the residence time of said end of said column coaxially in an interior of said needle based on sample quantity, which migrates by capillarity from said needle into said column inserted therein.

7. The apparatus as claimed in claim 6, wherein the insert comprises a widened portion positioned between the first cylindrical cavity for guiding the needle and the second cylindrical cavity for guiding the column.

8. The apparatus as claimed in claim 6, wherein the sampler is provided with means for gradually regulating a height of a sample meniscus within the needle as said sample migrates from the needle to the column.

9. The apparatus as claimed in claim 8, wherein said regulating means comprise a member for relatively moving one or more of the needle or the terminal portion of the column along the respective guide cavities of said insert.

10. The apparatus as claimed in claim 8, wherein said regulating means comprise a member for moving a plunger of said syringe.
